(19) United States
(12) Patent Application Publication
(10) Pub. No.: US 2007/0084455 A1
(43) Pub. Date: Apr. 19, 2007

(54) MULTI-PLANE COOKER

(76) Inventor: Norberto JORGE GARCIA, Madrid (ES)

Correspondence Address: OSTROLENK FABER GERB & SOFFEN, 1180 AVENUE OF THE AMERICAS, NEW YORK, NY, 100368403, US

(21) Appl. No.: 11/539,398

(22) Filed: Oct. 6, 2006

(30) Foreign Application Priority Data
Oct. 7, 2005 (ES) ES U 200502194

(51) Int. Cl. A47J 37/07

(52) U.S. Cl. 126/25 A

(57) ABSTRACT

The invention relates to a multi-plane cooker having one or more heat energy sources for cookers with at least one at least one upper heat energy source located at a greater height than said lower heat energy sources. These energy sources can be burners, vitroceramic cooktops, induction cooktops or similar means. This system allows taking greater advantage of the volume on the lower burners, which allows preparing a larger number of cooked dishes in a lower cooking level.

### OBJECT OF THE INVENTION

The object of the present invention is to optimize the space and volume occupied by a cooker, with the aim of being able to cook a greater number of dishes simultaneously. The cooker object of the invention allows cooking at several heights and also makes it possible to use the heat generated by the burners to keep the dishes warm until they are served to the diners.

### BACKGROUND OF THE INVENTION

Domestic and professional cookers are traditionally conceived as a generally rectangular horizontal work surface on which several burners are arranged. The horizontal surface occupied by a cooker is increased so as to have a greater number of burners in order to increase the working capacity of the cooker. Conventional cookers exclusively have an access area at one of the faces of the cooker since the access to the side or rear faces is closed by a wall or an adjacent piece of furniture.

On the other hand, paella or patella dishes increase in diameter but not in height because cooks look for a large cooking surface which allows cooking dry rice. To that end, a very reduced layer of grains at the bottom of the cooking vessel is essential, which is equivalent to large surfaces of the vessel in relation to limited grams of rice. Therefore, restaurants specializing in paella rice dishes have the problem of needing large fire (and therefore burner and cooker) surfaces in order to cook a large number of paellas at the same time. A large number of cooks solve this problem by finishing the cooking of the paellas in the oven, which involves serious consequences for the final result of the dish.

### DESCRIPTION OF THE INVENTION

The present invention solves the technical drawback set forth by providing a multi-plane cooker comprising a surface in which one or more heat energy sources for cookers are arranged, and it is characterized in that it has at least one upper heat energy source located at a greater height than the lower energy sources. These energy sources can consist of burners, vitroceramic cooktops, induction cooktops or similar means.

The innovative design of the cooker makes it possible to use the volume arranged on the lower burners so as to have an upper level of burners allowing the preparation of dishes on an upper level.

### DESCRIPTION OF THE DRAWINGS

To complement the description being made and with the aim of aiding in better understanding the features of the invention according to a preferred embodiment thereof, a set of drawings is attached as an integral part of said description in which the following has been depicted with an illustrative and non-limiting character:

FIG. 1 shows a schematic perspective view of the multi-plane cooker object of the invention.

FIG. 2 shows an upper plan view of the cooker.

FIG. 3 shows a perspective view of the cooker object of the invention with several planar cooking vessels.

FIG. 4 shows a front elevational sectional view of a planar cooking vessel.

FIG. 5 shows an upper plan view of the vessel of FIG. 4.

### PREFERRED EMBODIMENT OF THE INVENTION

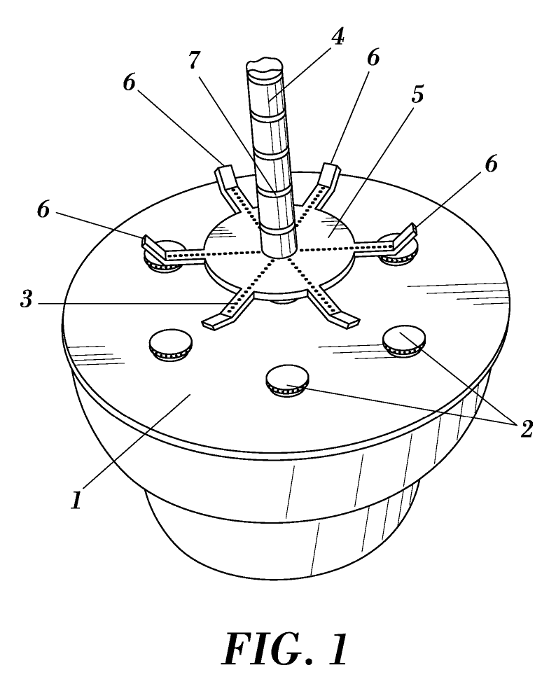

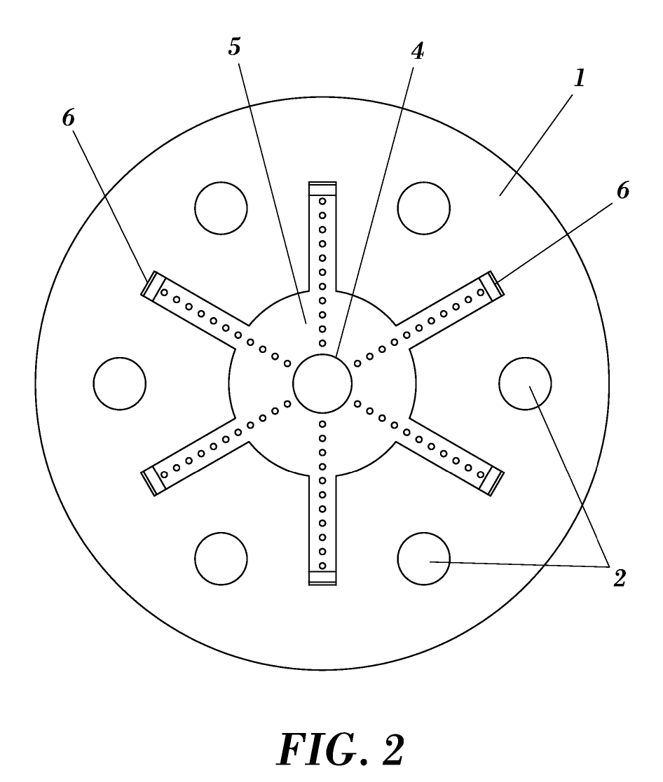

In view of FIG. 1, it can be seen how in this preferred embodiment, the multi-plane cooker object of the invention has a circular configuration and is formed of an also preferably circular surface (1) in which a first group of lower heat energy sources is arranged, in this case, lower burners (2). In view of FIGS. 1 and 2, it can be seen how in this embodiment, these energy sources are distributed in said surface (1) equidistantly from each other and circumferentially with respect to the center of the cooker. In other embodiments, these energy sources can be distributed in any manner that is considered to be suitable, not necessarily equidistant or circumferential.

Naturally in other practical embodiments of the invention, the outline of the surface (1) can adopt any polygon shape, such as hexagonal or octagonal for example, instead of being circular.

The circular configuration of the cooker allows optimizing the use of the available surface since the unused area of this surface is concentrated in the central area (3) of the surface (1), which can be used to arrange a vertical support (4) in which a structure (5) is in turn assembled. A group of upper burners (6), which are arranged at a higher level than the group of lower burners (2), is arranged in this structure (5). These burners (6) are also distributed circumferentially and equidistantly, and in this preferred embodiment they are arranged closer to the support (4) or center of the cooker than the group of burners (2). Alternatively, the structure (5) can be assembled or supported in the central area (3) of the surface (1).

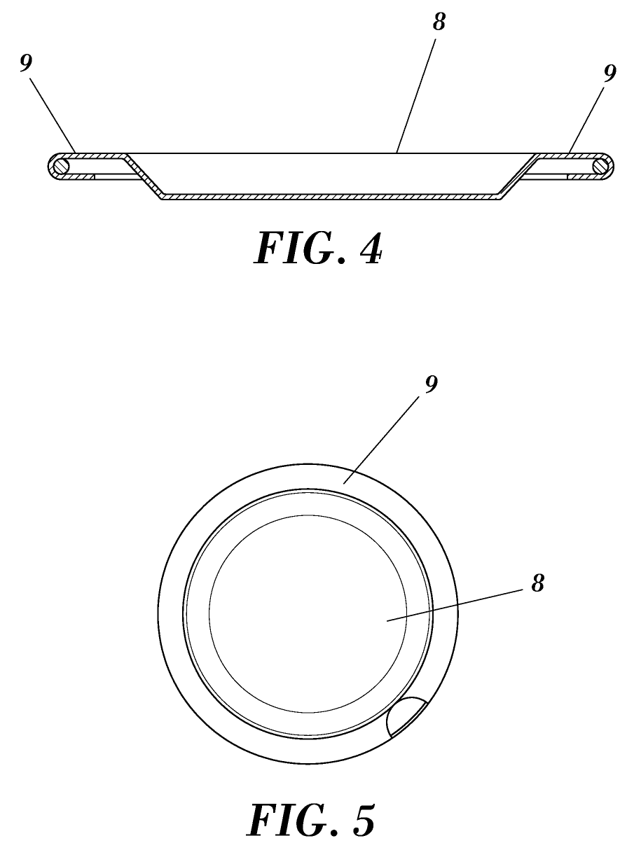

The cooker is preferably intended for the use of planar vessels, such as patella or paella dishes, such as for example the one shown in FIGS. 4 and 5. These patella or paella dishes are preferably made of a suitable metallic material, although they can also consist of vessels of ceramic material.

The vertical support (4) has holding means which allow retaining one of the mentioned planar vessels (8) in a stable position, having several of these means at different heights of the support (4). Said holding means can allow a vessel (8) to rotate around the support (4). In one embodiment, these holding means consist of an opening (7) adapted in shape and size to allow the insertion and retention of the edge (9) of one of the vessels (8).

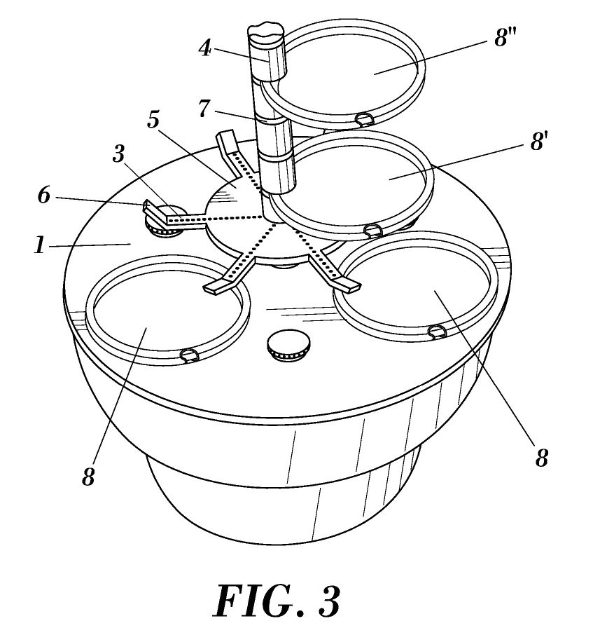

FIG. 3 shows the cooker during its use, in which it can be observed that the invention allows the use of multiple vessels in a reduced space, i.e. the simultaneous preparation of multiple dishes such as paellas for example. This is due to the concept of a multi-plane cooker enabling the use of the volume arranged over the lower burners (2) so as to have an upper level of burners allowing the preparation of dishes at a higher height level. A few vessels have been shown in FIG. 3 for the sake of simplicity, but of course one vessel for each of the lower and upper burners can be used in the cooker.

In the case of FIG. 3, the upper level vessels (8′) are retained by their edge (9) in one of the openings (7) of the support (4), such that said vessel is arranged on one of the upper burners (6).

The circular configuration of the cooker further allows the movement of the cook around it, therefore he/she can access each of the vessels more comfortably. Furthermore, the cook or chef can have a greater coordination of dishes before him/her, which allows cooking a larger number of paellas at the same time, some overlapping others because these vessels have a height that does not exceed a maximum of 5 centimeters. The vertical support (4) can have a space inside it to allow the passage of a gas duct for the upper burners (6) for example. This configuration even allows the simultaneous participation of two or more cooks, each one working in a semicircle or area of the cooker for example.

The vertical support (4) has openings (7) at different heights, which allows placing already cooked paellas above the burners such that the generated heat is used to keep the finished paellas that are ready to be served to diners warm. The openings (7) can be formed in a ring which rotates with respect to the vertical support (4) such that its position can be modified as needed.

With the same novel concept of a cooker optimizing space and growing vertically instead of horizontally, the vertical support (4) can be used to incorporate utensils or equipment conventionally used in a kitchen, such as an oven, a plate warmer, grills etc.

Given the innovative design of such a compact, efficient and harmonic cooker, the kitchen itself acquires an appealing appearance that invites placing it in view of the diners in a restaurant, either in the center of the premises or near an exterior window, such that the diners and/or passersby can contemplate the preparation of the paellas.

Several practical embodiments of the invention are described in the attached dependent claims.

In view of the description and the set of drawings, a person skilled in the art can understand that the embodiments of the invention which have been described can be combined in multiple ways within the object of the invention. The invention has been described according to several preferred embodiments thereof but it will be evident for a person skilled in the art that multiple variations can be introduced in said preferred embodiments without exceeding the object of the claimed invention.

1. A multi-plane cooker comprising a surface on which one or more lower heat energy sources for cooking are arranged, characterized in that it has at least one upper heat energy source located at a greater height than said lower heat energy sources.

2. A multi-plane cooker according to claim 1, wherein the lower and upper heat energy sources are of the same type.

3. A multi-plane cooker according to claim 1, wherein the heat energy sources are burners.

4. A multi-plane cooker according to claim 1, wherein the heat energy sources are induction cooktops.

5. A multi-plane cooker according to claim 1, wherein the heat energy sources are vitroceramic cooktops.

6. A multi-plane cooker according to claim 1, wherein the cooker has a substantially circular or polygonal configuration.

7. A multi-plane cooker according to claim 1, wherein the lower heat energy sources are distributed circumferentially on the surface.

8. A multi-plane cooker according to claim 1, wherein it has a vertical support assembled in a substantially orthogonal manner in said surface.

9. A multi-plane cooker according to claim 1, wherein it has a structure located on said surface, the upper heat energy sources (6) being arranged in said structure

10. A multi-plane cooker according to claim 9, wherein the structure is assembled in the vertical support.

11. A multi-plane cooker according to claim 9, wherein the structure is assembled on the surface.

12. A multi-plane cooker according to claim 1 wherein the upper heat energy sources are closer to the center of the surface than the lower heat energy sources.

13. A multi-plane cooker according to claim 1 wherein the vertical support has openings.

14. A multi-plane cooker according to claim 2, wherein the heat energy sources are burners.

15. A multi-plane cooker according to claim 2, wherein the heat energy sources are induction cooktops.

16. A multi-plane cooker according to claim 2, wherein the heat energy sources are vitroceramic cooktops.
